(19) United States
(12) Patent Application Publication
(10) Pub. No.: US 2012/0131655 A1
(43) Pub. Date: May 24, 2012

(54) User Authentication Device and Method

(75) Inventors: Jason Frederick Bender, Osmond (AU); James Evan Lenon, Unley (AU); Simon Charles Hughes Hewitt, Templestowe (AU)

(73) Assignee: EMUE HOLDINGS PTY LTD., MELBOURNE (AU)

(21) Appl. No.: 13/319,984

(22) PCT Filed: May 11, 2010
(86) PCT No.: PCT/AU10/00546

§ 371 Date: Feb. 2, 2012

(30) Foreign Application Priority Data
May 11, 2009 (AU) 2009902095

(51) Int. Cl. G06F 21/00

(52) U.S. Cl. 726/6

(57) ABSTRACT

An authentication device (100) for use with electronic security devices and user authentication systems is disclosed. The authentication device includes a data store (104) for storing plural secret keys, each secret key associated with a corresponding service, a service selection means (101) for selecting a service from the corresponding services, an authentication code generator (102) for generating, from the secret key associated with the selected service, a one time usable authentication code for communication to an authentication controller associated with the selected service, and an output (106) for outputting the generated authentication code for communication to the authentication controller. A method of authentication a user to a service is also disclosed.

This application claims priority from Australian Provisional Patent Application No. 2009902095 filed on 11 May 2009, the contents of which are to be taken as incorporated herein by this reference.

### FIELD OF THE INVENTION

The present invention relates to electronic security devices and systems for user authentication. In a typical application a device in accordance with an embodiment of the invention may be used to generate an authentication code for authenticating a user.

### BACKGROUND OF THE INVENTION

The use of electronic commerce systems for conducting electronic transactions involving a user and a transaction system is commonplace. Such systems may be used for Internet banking, on-line shopping, automatic teller machine access, share trading, bill payment, and the like.

A significant requirement for a secure electronic transaction in an electronic commerce system involves authenticating the user to the system. In other words, verifying that the user is who they claim to be.

One approach for authenticating a user involves providing the user with an electronically readable device, such as a card, containing magnetically stored information about the user. In order to allow the user to use his card, an entity (such as a bank) provides the user with a unique code (such as a PIN) to be supplied when using the card for an electronic transaction with a transaction system (such as an automatic teller machine) associated with the entity. One difficulty with such a method is that the same code is used each time the user authenticates with a system. This increases the risk of another party, such as an attacker, acquiring the unique code and thus conducting an unauthorised transaction.

Another approach involves providing the user with a device which generates a one time useable authentication code, such as a one time passcode (OTP). Such a device may generate a OTP each time the device is used. One example of such a device includes a token or smart card which generates a OTP derived from a secret (or “secret key”) stored in memory of the device. Since the secret is also known to an authentication system associated with the device the secret is typically referred to as a “shared secret”. When the user authenticates with an authentication or security system the authentication system generates an expected code value, which is derived from the shared secret, and compares the expected code value with the OTP to authenticate the user.

In a security system involving an OTP device and an authentication system, user authentication may involve the user providing the OTP to an entity's (such as a bank) transaction system, which then communicates the OTP to a remote authentication system or infrastructure managed by an authentication service provider for authentication of the user. In some systems, the authentication system may be capable of authenticating the user to another entity's transaction system to thus enable the user to authenticate with multiple transaction systems. Such a system is typically referred to as a federated system.

In a federated system the transaction system does not need knowledge of the shared secret, since it relies on the authentication system of the authentication service provider to conduct the authentication process. Hence, a federated system may provide federated access for multiple transaction systems and involve a single shared secret which may used in conjunction with multiple types of transactions of the same or varying risk.

With today's ever changing requirements for stronger online authentication, identity protection, transaction signing, bi-directional authentication and the like, federated access has been marketed as a means of limiting the need of a user to carry multiple authentication devices because each user may use a single device for the provision of the service they wish to perform, regardless of the entity (such as an enterprise or organisation) with which they wish to perform it.

Unfortunately, a limitation of federated systems is that they may allow opportunities for cross channel fraud and threats associated with one entity being compromised by means of phishing, secret keystroke logging or any other threat. If realised, such threats may allow an attacker to secure information required to authenticate. Such information may then be used to exploit a service provided by an independent entity who has also subscribed to the same federated service. Such limitations may be exacerbated when relying on a single device to facilitate authentication services for activities of different risk.

At present, it is believed that a single authentication device cannot be used to access multiple independent authentication systems without sharing the “secret” with those systems. However, since different authentication systems may be associated with different types of transactions or services, and thus different risk activities, revealing the secret to an authentication system associated with low risk activities (such as logging on to a membership based general information service) may comprise the security of authentication systems associated with high risk activities (such as on-line bank account access).

There is a need for an improved authentication device for authenticating a user to multiple services.

Reference to any prior art in this specification is not, and should not be taken as, an acknowledgment or any form of suggestion that this prior art forms part of the common general knowledge in any country.

### SUMMARY OF THE INVENTION

The present invention provides an authentication device, including:

a data store for storing plural secret keys, each secret key associated with a corresponding service;

a service selection means for selecting a service from the corresponding services;

an authentication code generator for generating, from the secret key associated with the selected service, a one time usable authentication code for communication to an authentication controller associated with the selected service; and

an output for outputting the generated authentication code for communication to the authentication controller.

A device in accordance with an embodiment may be capable of authenticating a user to multiple services. Preferably, an embodiment manages and stores the plural secret keys and other information necessary and sufficient to provide the security sought by each sharing interest, in other words, the user and the service(s).

Preferably, each secret key is loaded into the authentication device during a manufacturing process via the use of a suitable communications interface. Thus, each secret key may be loaded into the authentication device prior to the card being issued to a user. However, it is also possible that a secret key(s) may be “loaded” into the authentication device during a device registration process involving communication with a service via the same or a different communications interface. One example of a suitable communications interface includes a smart-card type communications interface in the form of a contact type or a contactless type interface. However, it will be appreciated that other types of wired or wireless communications interfaces may be used, such as an IEEE802.11 based wireless interface, a general packet radio service (GPRS) compatible interface, a wireless application protocol (WAP) compatible interface, a Bluetooth interface, an optical interface (such as an IrDA interface), an audio interface, a magnetic interface (such as a magnetic stripe), a ZigBee interface, a universal serial bus (USB) interface, or an radio frequency identification (RFID) induction based communication interface.

A device in accordance with an embodiment of the invention preferably stores a number of secret keys based on the requirements of the user with the actual number of secret keys determined by the number of services, or groups of services, requiring a unique authentication code. The collection of plural secret keys forms a “secret key set”.

An advantage of the present invention is that it may use a single secret key set comprising plural secret keys, wherein each secret key is for use with an associated service comprising either an independent service(s) or a federated service arrangement, and thus provides user authentication services for multiple services. Moreover, although the device stores plural secret keys, since each key is associated with a particular corresponding service or a particular group of services, and is used to generate the authentication code exclusively for that service or services, use of a secret key for one service does not compromise the secret keys for the service(s) having an association with a different secret key. In other words, each of the plural secret keys is exclusively associated with a particular service, or a particular group of services, of the set of services supported by the device, and thus is not involved in the generation of an authentication code for the other services of the set of services supported by the device. The other services, or the other groups of the other services, will be exclusively associated with a different one of the secret keys of the secret key set.

The present invention also provides a method of authenticating a user to a service, including:

storing plural secret keys in a data store of a user device, each secret key associated with a corresponding service;

the user operating the user device to select one of the corresponding services;

the user device generating an authentication code for authenticating the user to the selected service, the generated authentication code being derived from the secret key associated with the selected service; and

outputting the generated authentication code for communication to an authentication controller associated with the selected service.

The present invention also provides a computer readable media including a set of instructions in the form of a computer software program, the instructions being executable by a processing device on-board an authentication device including a data store storing plural secret keys, each secret key being associated with a corresponding service, such that execution of the instructions causes the authentication device to:

prompt a user to select a service from the corresponding services;

generate, from the secret key associated with the selected service, a one time usable authentication code for communication to an authentication controller associated with the selected service; and

output the generated authentication code for communication to the authentication controller.

Embodiments of the present invention may provide a single authentication device which may be used or shared across multiple services without requiring each service to share secret information or be technically integrated or communicate with each other.

### BRIEF DESCRIPTION OF THE DRAWINGS

An embodiment of the invention will now be described, by way of example only, with reference to the accompanying drawings in which:

FIG. 1 is a block diagram of an authentication device according to an embodiment of the present invention;

FIG. 2 is a lower level block diagram of the authentication device of FIG. 1;

FIG. 3 is a front view of a card form of the authentication device of FIG. 1;

FIG. 4 is a block diagram of a authentication system incorporating a device in accordance with an embodiment of the present invention;

FIG. 5 is a flow chat of an embodiment of an authentication method according to the invention;

FIG. 6 is a block diagram of another authentication system incorporating a device in accordance with an embodiment of the present invention; and

FIG. 7 is a block diagram of an authentication system incorporating a device in accordance with the second embodiment of the present invention.

### DETAILED DESCRIPTION OF THE INVENTION

Before proceeding to describe the present invention, and embodiments thereof, in more detail it is important to note that various terms that will be used throughout the specification have meanings that will be well understood by a skilled addressee. However, for ease of reference, some of these terms will now be defined.

The term “federated service”, and variants thereof, as used throughout the specification denote a service whereby one system can authenticate a user against the credentials controlled and stored by another service, such as a remote authentication system managed by an authentication service provider. One example of a federated service is the OpenID project. Another example of a “federated service” is the VeriSign VIP authentication service described at: http://www.verisign.com.au/authentication/consumer-authentication/vip-authentication/.

The term “independent service”, and variants thereof, as used throughout the specification denote a service whereby the authentication occurs against user credentials controlled and stored by that service. An example of an independent service is the PayPal account authentication service requiring the Paypal security key described at: https://www.paypal.com/au/securitykey.

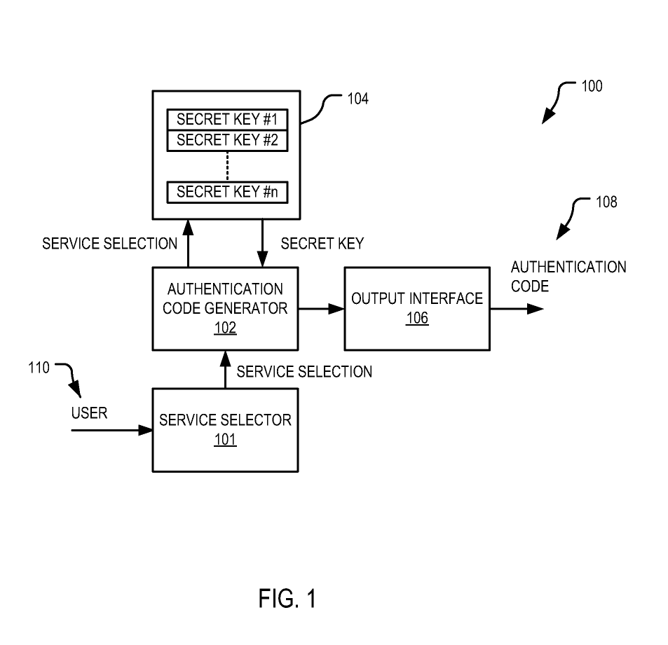

FIG. 1 shows a block diagram of an authentication device 100 according to an embodiment of the present invention. As shown, the authentication device 100 includes a service selector 101, an authentication code generator 102, a data store 104 and an output interface 106. The authentication device 100 is operable by a user 110 and thus in this context is a “user device”.

The authentication code generator 102 generates an authentication code 108 for authenticating the user 110 to a selected service, which may include an independent service or a federated service selectable from the set of services supported by the device 100. The selected service may thus include any service which is supported by the authentication device 100 and which requires user authentication. By way of example, such services may include an electronic data interchange service (such as an on-line banking service, share trading service, an on-line shopping service, or the like), a computer network service (such as a network log-on service), a communications service (such as an email service or a messaging service), a membership based service (such as a on-line forum, a car-rental service, or a health service), a security service (such as a building access service), or the like.

The authentication code 108 may include, for example, a code comprising a sequence of alphabetic, numeric (for example, 18574632), or alphanumeric characters (for example, 18fy4o@t55) of various lengths. Suitable authentication code structures would be well understood by a skilled addressee.

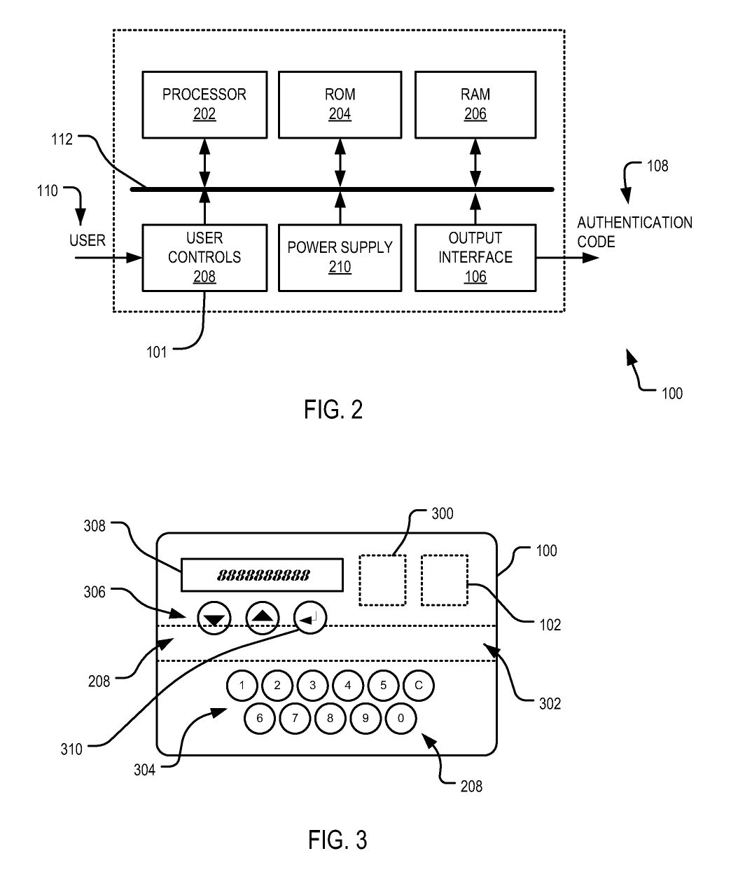

The authentication code generator 102 is implemented using hardware, software and/or firmware elements of the authentication device 100. In the embodiment illustrated in FIG. 2 the hardware, software and/or firmware elements of the authentication code generator 102 (ref. FIG. 1) include a processor 202, such as a microprocessor or microcontroller, for executing an instruction set in the form of a computer software program resident in a memory 204 accessible to the processor 202. Examples of suitable processors include the 6502, ARM, Motorola 6800, and Texas Instruments MSP430 processors. It will be appreciated that other processors may also be suitable. A power supply 210, such as a battery, or an induction coil, is provided to supply electrical power to the processor 202 and the other functional components of the authentication device 100.

The memory 204 includes a read-only memory (ROM) 204 (such as an EPROM or EEPROM) on-board the processor 202. However, it is possible that the memory 204 may be external to the processor 202. A random access memory (RAM) 206 is also provided to provide working memory for the processor 202. A suitable minimum memory size would be 1 kilobyte of RAM and 16 kilobytes of ROM.

The data store 104 (ref. FIG. 1) is a memory segment of the device 100 which has been allocated for storing the plural secret keys, with each secret key being associated with a corresponding service. The memory segment may be a segment of the ROM 204, the RAM 206, or another memory.

Each secret key may include, for example, a seed, code or data sequence (such as an n-bit sequence) which is processed by the authentication code generator 102 to generate a unique authentication code 108 for a selected service supported by the authentication device 100. In the present case, each secret key is a 256 bit binary value. However, it will of course be appreciated that other n-bit values may be used.

In the embodiment illustrated, the authentication code generator 102 generates the authentication code 108 after the user 110 has entered a personal identification number (PIN) into the authentication device 100 and selected the service using the service selector 101. The PIN may be a code which has been issued to the user 110 by the provider of the selected service, such as a bank, or other service provider. Alternatively, the PIN may be a “device PIN” (DPIN) associated with the authentication device 100 itself, in which case the DPIN will need to be correctly entered into the device 100 before the device 110 will permit the user 110 to access the service selection functions, and thus to enable the authentication code generator 102. Embodiments may use either or both PIN types.

The selection of the service and the entry of the PIN may thus be made in any order, with the order possibly depending on the PIN type. However, it is preferred that the user 110 first selects the service and then enters the PIN for that service. As will be appreciated, where an authentication process for a selected service authenticates the user 110 via a federated authentication service, the same PIN may be used for each supported service which utilises the federated authentication service.

With reference now to FIG. 3, operating the service selector 101 to select a service may involve the user 110 operating user controls 208, such as keys or buttons, on the authentication device 100 to select the service from the set of services supported by the authentication device 100. In this respect, FIG. 3 shows an embodiment of an authentication device 100 in the form of an “electronic card” or “smart-card” which includes an arrangement of user controls 208 operable by the user 110 to enter a service selection and perform other user functions.

In the illustrated example the arrangement of user controls 208 includes a numerical keypad 304, arrow buttons 306 for selecting or controlling options or functions displayed on a display module 308, and an enter key 310. It will of course be appreciated that illustrated configuration of user controls 208 is to be understood as a non-limiting example and different configurations of user controls 208 may be used.

In the illustrated example, entering a service selection involves selecting a service from a list of services which are displayed on the display module 308. A suitable display module 308 may include an LCD display, an LED display, an electrophoretic display or the like coupled to suitable display driver electronics. One particularly suitable display type is E Ink Corporation's “E-Ink electronic paper”. Such a display type is expected to be particularly suitable for a smart-card type embodiment due to its low profile physical form factor and low power requirements.

In the embodiment illustrated in FIG. 3 the user 110 enters the authentication device 100 into a “service selection mode” by, for example, entering their “device” PIN into the authentication device 100. The user 110 then selects a service by scrolling, using the arrow buttons 306, through a list of supported services displayed on the display module 308, and selecting the required service. However, in some embodiments, the authentication device 100 may include one or more controls, such as keys or buttons, which are each associated with a respective service so that operating a key or button selects the respective service. In either case, the keys or buttons may include membrane switches. In some embodiments the service selection may be a voice activated function in which case the authentication device will need to be equipped with an audio input (such as a microphone) and suitable audio signal processing functionality. In other embodiments, the service selection may involve selecting a service from the set of supported services by way of a communication process involving the authentication device 100 and a communications device in communication with the service to be selected, or requiring or requesting the authentication code 108. The communications device may include, for example a communications terminal equipped with a card reader, such as an Automatic Teller Machine (ATM), or other compatible communications interface for communicating with the authentication device 100.

An embodiment of the authentication device 100 which communicates with a communications device may automatically select the service in response to detecting the communications device, such as a communications terminal, in proximity or communication with the authentication device 100, being a communications device associated with the service requiring or requesting an authentication code 108. Such a selection process may or may not require the involvement of the user 110 in the selection process. Thus, as will be explained in more detail below, some embodiments of the authentication device 100 include a communications interface supporting data communication with the communications device or terminal associated with the service requiring or requesting an authentication code 108 for the purpose of identifying the terminal and/or selecting the service associated with or provided by the communications device or terminal.

By way of example, a service selection process which involves the authentication device 100 communicating with a communications device may involve the communications device communicating a service identifier which identifies the service to the authentication device 100. The service identifier will be decodable by the authentication device 100 to make a service selection based on the communicated service identifier. In other words, the service identifier will provide the authentication device 100 with information which identifies the service and thus enables the service selection. Communication between the authentication device 100 and the communications device may involve a suitable communications interface. Suitable communications interfaces may include wired or wireless interfaces such an IEEE802.11 based wireless interface, a general packet radio service (GPRS) compatible interface, a wireless application protocol (WAP) compatible interface, a Bluetooth interface, an optical interface (such as an IrDA interface), an audio interface, a magnetic interface (such as a magnetic stripe), a ZigBee interface, a universal serial bus (USB) interface, or an radio frequency identification (RFID) induction based communication interface. Hence, communication between the authentication device 100 and the communications terminal may involve contact or contactless communication.

Having made a service selection and retrieved the associated secret key from memory, processing the secret key to generate an authentication code 108 may involve a cryptographic hash function, such as an SHA-1 hashing function, which produces the authentication code as a hash output having a format compatible with the requirements, such as the data protocol, of the selected service. In other words, the authentication code generator 102 of the authentication device 100 may generate the authentication code 108 using a cryptographic algorithm or function which depends on the selected service. Hence, although in the present case a SHA-1 hashing function has been applied it will be appreciated that the hashing function, and thus the format (for example, the length) of the authentication code 108, may vary according to the requirements of the selected service. Suitable hashing functions would be known to a skilled reader.

The output interface 106 provides the generated authentication code 108 for communication to an authentication controller accessible to or associated with the selected service. Each authentication controller may include, for example, an authentication server which provides authentication services to the one or more respective services via a networked arrangement.

Communication of the authentication code 108 to the authentication controller may be performed by any suitable means. For example, communication of the authentication code 108 may involve the authentication device 100 displaying the authentication code 108 to the user 100 on display 308 (ref. FIG. 3) for the user 110 to communicate to the service by a suitable communication means. Alternatively, communication of the authentication code 108 may involve the authentication device 100 communicating the authentication code 108 to the service via a suitable communications network. Thus, depending on the communication requirement, the output interface 106 may include a visual display output interface, in the form of a display module 308, a magnetic stripe, a wired or wireless data communications output interface, or an audio output interface.

The output interface 106 thus includes suitable hardware and software elements (such as drivers) for outputting the authentication code 108 in a desired format and/or communications protocol, with the actual format and/or communications protocol depending on the output type. For example, in an authentication device 100 which includes a display module 308 (ref. FIG. 3), the output of the authentication code 108 may include the display module 308 outputting the authentication code 108 to the user 110 as text for manual entry into a communications terminal by the user. Thus, the display module 308 may form the output interface 106.

On the other hand, in an authentication device 100 which includes a output interface 106 (such as a wired or wireless transmitter) configured for data communication of the authentication code 108, suitable output interfaces may include wired or wireless interfaces such as, for example, an IEEE802.11 based wireless interface, a general packet radio service (GPRS) compatible interface, a wireless application protocol (WAP) compatible interface, a Bluetooth interface, an optical interface (such as an IrDA interface), an audio interface, a magnetic interface (such as a magnetic stripe), a ZigBee interface, a universal serial bus (USB) interface or the like. Other suitable interfaces would be well known to a skilled reader.

As is shown in FIG. 2, the illustrated embodiment of the authentication device 100 includes communications architecture 112 which permits data communication between the functional modules of the authentication device 100, the functional modules being the service selector 101, the authentication code generator 102, data store 104, and the output interface 106. The communications infrastructure 112 may include conventional busses, such as, a data bus, a control bus and an address bus. Suitable communications infrastructures would be known to a skilled reader.

Although the above described example relate to an embodiment which is implemented in the form of an electronic card having a credit card type geometry, it is possible that other embodiments will be implemented in other forms. For example, embodiments of the authentication device may be implemented on a mobile device equipped with suitable processing infrastructure, such as a mobile phone, a personal digital assistant (PDA), a laptop computer, a hand-held computer, or the like, programmed with software instructions which are executable by the processing infrastructure to provide the above-described functionality. Similarly, other embodiments may be implemented as a desktop computer programmed with executable software program to with software instructions which are executable by the processing infrastructure to provide the above-described functionality. Thus, it will be appreciated that an authentication device in accordance with an embodiment of the present invention may be implemented on different hardware ‘platforms’.

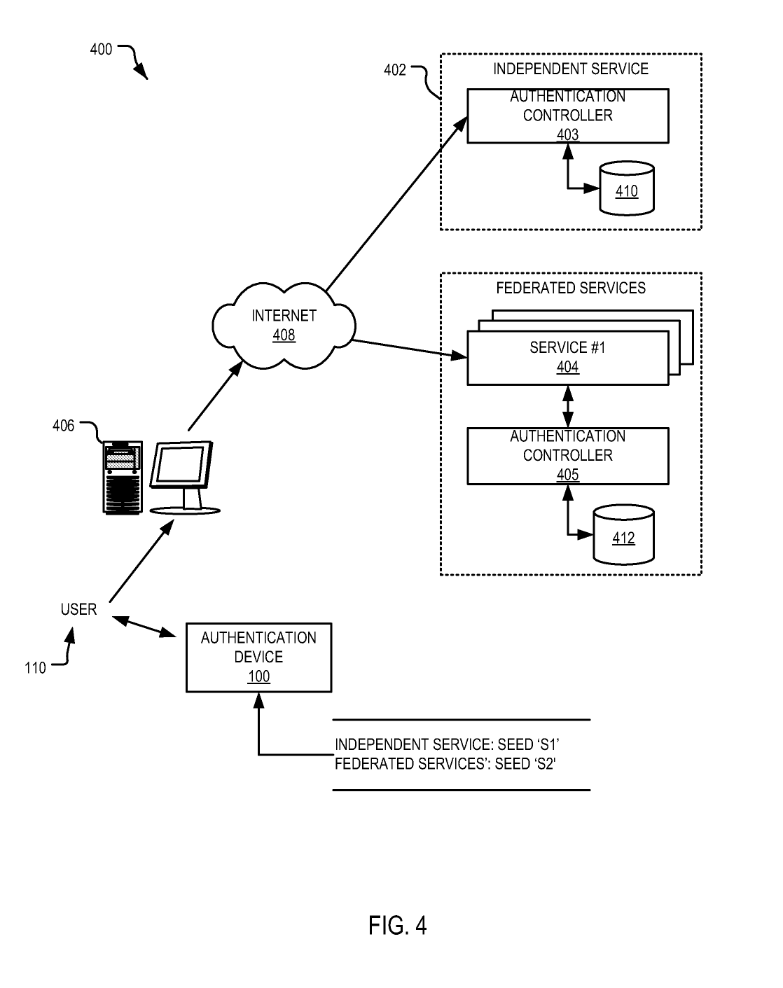

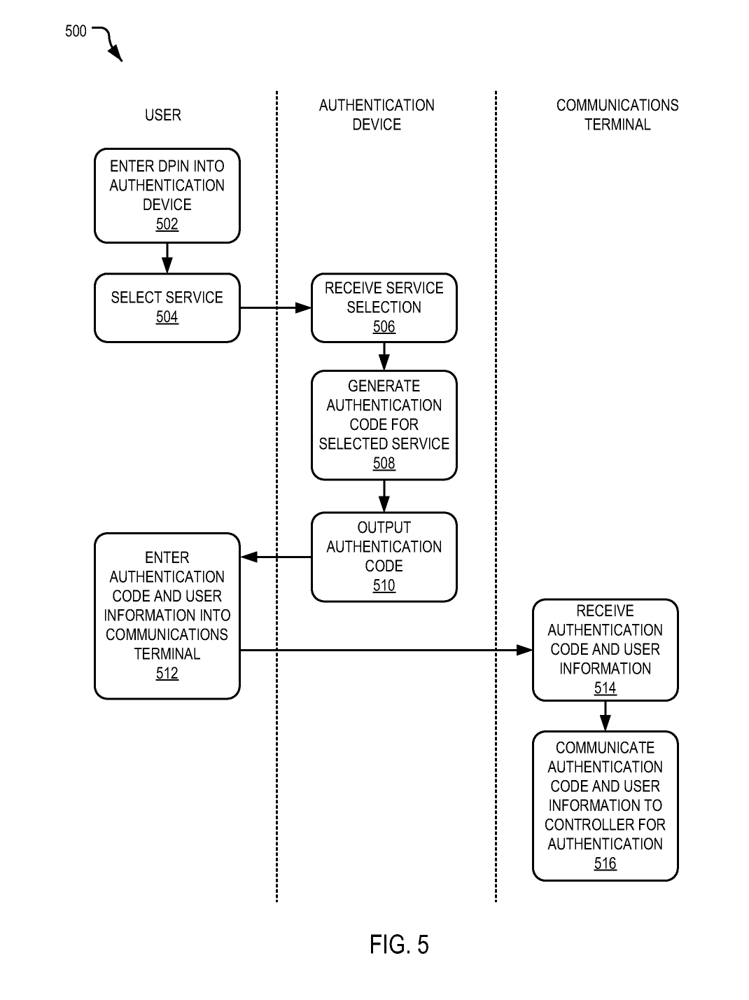

Examples of generating an authentication code 108 in the form of a one time usable passcode (OTP) will now be described with reference to FIG. 4 and FIG. 5.

### EXAMPLE 1

The following example relates to an example authentication code generation process, in the form of a cryptographic algorithm, for generating an authentication code in the form of a OTP for a selected service. In this example, and with reference now to FIG. 4, the authentication device 100 stores two “secrets” in the form of “seeds” “S1”, “S2”. Each seed is associated with a different corresponding service or group of services. In this example, seed “S1” is associated with the independent service 402, and seed “S2” is associated with the federated services 404. It will of course be appreciated that the use of two seeds is merely for the purposes of this example and it is possible that embodiments of the authentication device 100 may store a larger number of seeds for other corresponding services or groups of services.

In this instance, each seed comprises a 256 bit binary code, wherein each 256 bit binary code seed is for a different service. In this example, and in hexadecimal form, the seeds are expressed as follows:

Independent Service:

### Seed S1: “26FF665995A97340F834EE552B4F5A0188280528BF12684122BE4D9607D47E1B”

Federated Services:

### Seed S2: “E4B84B8D29F038D28CA750C13C8FCF5A8CC1EDBD40AF8529F88FC4CC04946083”

In this example, the authentication device 100 maintains a separate counter for each service, namely, “Counter A” for independent service 402, and “Counter B” for federated services 404. Each counter is incremented whenever a respective authentication code is generated, and thus on each iteration of the authentication code generation process for the corresponding service. Each counter may include a 24-bit (3-byte) up-counter which is reset either during manufacture or on initial registration of the authentication of the device 100 for a service. It is anticipated that the total number of authentication code iterations supported by a 24-bit counter will exceed the actual number of authentication code generation iterations expected to be performed by the authentication device 100 over its operable life.

Turning to FIG. 5, to initiate authentication code generation, the user 110 enters a PIN into the authentication device 100 at step 502 and operates the device 100, at step 504, to enter a service selection, which in this case instructs the device to generate the authentication code for “Service #1” of the federated services 404 using the authentication code generation process for that service.

On receiving the service selection at step 506 the authentication device 100 enters an authentication code generation mode to generate an authentication code for “Service #1” at step 508. In this example, generating an authentication code for “Service #1” involves the sequence outlined below. However, it is to be appreciated that whilst the following sequence provides one example of one suitable technique for generating an authentication code, other suitable techniques would be well within the knowledge of a skilled reader. Thus, it is to be understood that other embodiments of the present invention may employ other authentication code generation processes or techniques. For the purposes of this example:

First, Counter B is incremented:

COUNTER B=COUNTER B+1

The resultant Counter B count value (COUNTER_B_VALUE) is then included in a logical operation with the seed “S2” using an XOR function to provide an intermediate value (IVALUE1) as:

IVALUE1=(S2) XOR (COUNTER_{—}B_VALUE)

A hash of the intermediate value is obtained using a hashing algorithm. In this example the hashing algorithm is the SHA256 hashing algorithm:

NEW_SECRET=SHA256(IVALUE1)

A hash of the PIN is also obtained using the SHA256 hashing algorithm. In this instance the PIN is a PIN associated with the service, as opposed to the device:

PIN_HASH=SHA256(PIN)

In this example, the hashed PIN (PIN_HASH), the new secret value (NEW_SECRET), and the incremented counter value (COUNTER_B_VALUE) are then included in an XOR logical operation and hashed using the SHA256 hashing algorithm to provide a 256 bit value as a second intermediate value:

IVALUE2=

SHA256((PIN_HASH) XOR (NEW_SECRET) XOR (COUNTER_{—}B_VALUE))

In this example, the resultant forty bits from bit positions 48 to 87 in IVALUE2 are kept and the rest discarded, to provide a third intermediate value as:

IVALUE3=IVALUE2(48, . . . , 87)

The retained forty bits are then converted to eight groups of five bits as follows:

IVALUE4_{—}1=IVALUE2(48, . . . , 52)

IVALUE4_{—}2=IVALUE2(53, . . . , 57)

IVALUE4_{—}3=IVALUE2(58, . . . , 62)

IVALUE4_{—}4=IVALUE2(63, . . . , 67)

IVALUE4_{—}5=IVALUE2(68, . . . , 72)

IVALUE4_{—}6=IVALUE2(73, . . . , 77)

IVALUE4_{—}7=IVALUE2(78, . . . , 82)

IVALUE4_{—}8=IVALUE2(83, . . . , 87)

The above eight groups of five bits are converted to a respective single digit value using a lookup table containing thirty-two values (that is, 2⁵). In this example, each value contained in the lookup table comprises a number selected from the numbers 0 to 9. The resultant eight digits are then assembled to generate the authentication code, at step 508, for output, at step 510. The output authentication code is entered, at step 512, into a communications terminal (such as a card reader, desktop computer, an automatic teller machine, or the like) associated with Service #1. The communications terminal receives the authentication code at step 514, for communication, at step 516, to an authentication sever for processing to authenticate the user 110. Thus, in this example the authentication code is assembled using the eight digits obtained from the following lookup operation:

DIGIT1=LOOKUP(IVALUE4_{—}1)

DIGIT2=LOOKUP(IVALUE4_{—}2)

DIGIT3=LOOKUP(IVALUE4_{—}3)

DIGIT4=LOOKUP(IVALUE4_{—}4)

DIGIT5=LOOKUP(IVALUE4_{—}5)

DIGIT6=LOOKUP(IVALUE4_{—}6)

DIGIT7=LOOKUP(IVALUE4_{—}7)

DIGIT8=LOOKUP(IVALUE4_{—}8)

The new secret value (NEW_SECRET) replaces the seed “S2” stored in device memory 104 for use as the seed for the next interaction of the authentication code generation process for providing an authentication code for use with the federated services 404. Replacing the seed “S2” with the new secret value (NEW_SECRET) may reduce susceptibility to differential power analysis (DPA) type attacks.

### EXAMPLE 2

The following example relates to another authentication code generation process, in the form of a cryptographic algorithm, for generating an authentication code in the form of a OTP using an authentication device 100 storing the same seeds “S1”, “S2” as those described with reference to Example 1. However, in this example, and with reference again to FIG. 4, the authentication code is generated for independent service 402, and thus uses seed “S1” and Counter A. In this instance, in contrast to Example 1, the process generates the authentication code without requiring a look-up table arrangement. Furthermore, this example requires one less hash operation which reduces processing demand and thus increases battery life. First, Counter A is incremented:

COUNTER A=COUNTER A+1

The resultant incremented Counter A count value (COUNTER_A_VALUE) is included in an XOR logical operation with the seed “S1” and hashed using the SHA256 hashing algorithm to provide a 256 bit value as a new secret value (NEW_SECRET), which in this example is a first intermediate value:

NEW_SECRET=SHA256(S1 XOR COUNTER_{—}A_VALUE)

The hashed new secret (NEW_SECRET) is included in an XOR logical with a value formed by appending COUNTER_A_VALUE to the PIN to provide a 256 bit value as a second intermediate value:

IVALUE2=NEW_SECRET XOR (COUNTER_{—}A_VALUE+PIN)

where the “+” sign above designates an append operation. The bits from bit positions 48 to 111 in IVALUE2 from the above operation are then converted into a single 8-digit value by way of the following operation:

DIGIT1=IVALUE2[ 48 . . . 55] MOD 10

DIGIT2=IVALUE2 [ 56 . . . 63] MOD 10

DIGIT3=IVALUE2 [ 64 . . . 71] MOD 10

DIGIT4=IVALUE2 [ 72 . . . 79] MOD 10

DIGIT5=IVALUE2 [ 80 . . . 87] MOD 10

DIGIT6=IVALUE2 [ 88 . . . 95] MOD 10

DIGIT7=IVALUE2 [ 96 . . . 103] MOD 10

DIGIT8=IVALUE2 [ 104 . . . 111] MOD 10

The resultant eight digits are then assembled as the authentication code, at step 508, for output, at step 510. The new secret value (NEW_SECRET) replaces the seed “S1” stored in device memory 104 for use as the seed for the next interaction of the authentication code generation process for providing an authentication code for use with the service 402. Replacing the seed “S1” with the new secret value (NEW_SECRET) may reduce susceptibility to differential power analysis (DPA) type attacks.

### EXAMPLE 3

### Use of the Authentication Device With Multiple Services

Turning now to FIG. 4 there is shown a block diagram of an authentication system 400 including services 402, 404, respective authentication controllers 403, 405, and databases 410, 412.

In this example, services 402, 404 represent the services for which the authentication device 100 may be operated to generate a one time usable authentication code for authenticating the user 110 to a selected one of the services 402, 404. In this instance, service 402 is an independent (non-federated) service, whereas service 404 is one of a group of federated services.

For this example, the authentication device 100 stores two “secret” keys, namely, seed “S1” and seed “S2”. Seed “S1” is associated with independent service 402, whereas seed “S2” is associated with federated services 404.

In use, to authenticate themselves to a service, the user 110 operates the authentication device 100 to select either service 402 or service 404. As explained above, selecting a service involves entering a PIN into the authentication device 100.

In response to the service selection, the authentication code generator 102 (ref. FIG. 1) of the authentication device 100 generates the one time usable authentication code for authenticating the user 110 to the selected service. The generated authentication code is derived from the secret key associated with the selected service using a suitable process, such as the process described in Example 1.

In this example, the authentication device 100 displays, and thus outputs, the generated authentication code to the user 110. The user 110 then enters the authentication code into the communications terminal 406 for data communication to an authentication controller 403/405 associated with the selected service 402/404. The data communication will also include information which is decodable by the authentication controller 403/405 to identify either the authentication device 100 or the user 110.

As briefly explained above, in this example, communication of the generated authentication code to an authentication controller 403/405 involves the user 110 entering the generated authentication code into a communications terminal 406 (such as a desktop computer, laptop computer, or mobile communications device) for communication to the authentication controller 403/405 via a suitable communications channel, which in this example is the internet 408. It will of course be appreciated that different communication channels may be used.

On receipt of the data communication, the authentication controller 403/405 conducts an authentication process to validate the received authentication code, such as by, for example, comparing the received authentication code against an expected code value generated using user information retrieved from the respective databases 410, 412, which includes the corresponding secret key for the user 110 and possibly other information, with the actual information depending on the authentication algorithm. In this instance, the authentication controller 403/405 applies the same algorithm applied by the authentication device 100 to generate the authentication code.

The above described example may represent, for example, an implementation in which the independent service 402 is of a different security category compared to the federated services 404 which may represent lower risk activities as compared to the independent service 402. Thus, in this example the authentication device 100 stores two secret keys, wherein each secret key is associated with a service or group services having a different security category. Thus, for example, a first secret key may have a unique association with a first service, and the second secret may have an association with plural services of a lower security category than the first service. In other words, the first secret key may only be used to generate an authentication code for a particular service whereas the second secret key may be used to generate an authentication code for plural services. In the latter case, each of the plural services will access or share the same authentication controller or authentication service. Systems and methods for establishing relationships between the services and an authentication controller or authentication services would be well known to a skilled reader.

### EXAMPLE 4

### Use of the Authentication Device For Direct Authentication With Service

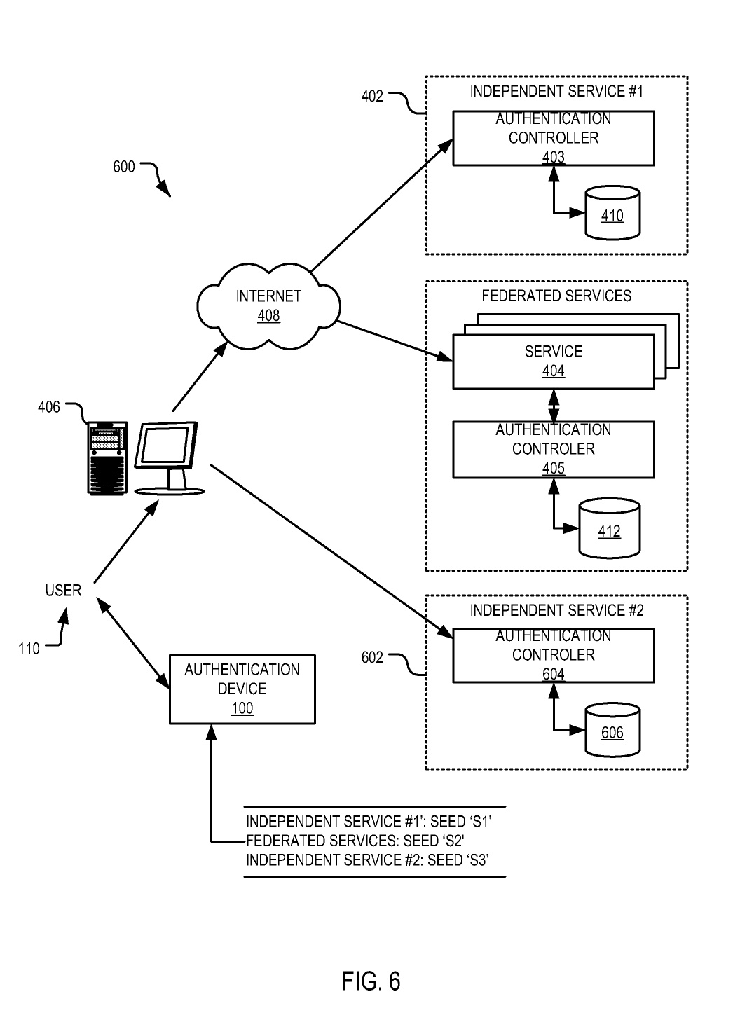

With reference now to FIG. 6 there is shown a block diagram of an authentication system 600 which has a generally similar architecture to the authentication system 400 illustrated in FIG. 4. The authentication system 600 includes the services 402, 404 of the authentication system 400. However, in this example, the authentication system 600 further includes independent service 602 (shown as “independent service #2”) and respective authentication controller 604.

The system illustrated in FIG. 6 shows an example in which the authentication device 100 stores three secret keys, namely, namely, seed “S1”, seed “S2” and seed “S3”. Seed “S1” is associated with independent service 402 (shown here as “independent service #1”); seed “S2” is associated with federated services 404; and seed “S3” is associated with independent service 602. Thus, in this example, services 402 and 604 are independent (non-federated) service, whereas service 404 is one of a group of federated services. Independent service 402 may include, for example, a banking service (such as an on-line bank account management service), whereas federated services 404 may include a variety of lower risk services, such as a email communications services, a web-forum communications service or the like, and independent service 604 may be user services on a computer network requiring the user to log-on to the network. Independent service 602 may include, for example, a service 602 which is able to receive the generated authentication code directly from the communications terminal 406 for authenticating the user 110 without the involvement of a third party.

The communications terminal 406 may include a security control panel in communication with a security system controlling access to a secured area, such as a property, building, car-park, house, safe, or the like. Alternatively, as explained above, the communications terminal 406 may include a computer terminal for providing user access to a computer network, via a suitable log-on process, on validation of an entered authentication code. Thus, an authentication process which involves the authentication device 100 may be a network log-on process.

Irrespective of the service, the authentication device 100 will generate an authentication code using the secret key for the respective service for providing to an authentication controller associated with the service to authenticate the credentials of the user 110. It is to be noted that for each service supported by the authentication device 100, generation of the authentication code by the authentication code generator 102 may involve the same authentication code generation process, or a different authentication code process.

### EXAMPLE 5

### Use of an Authentication Device With In-built Communications Interface

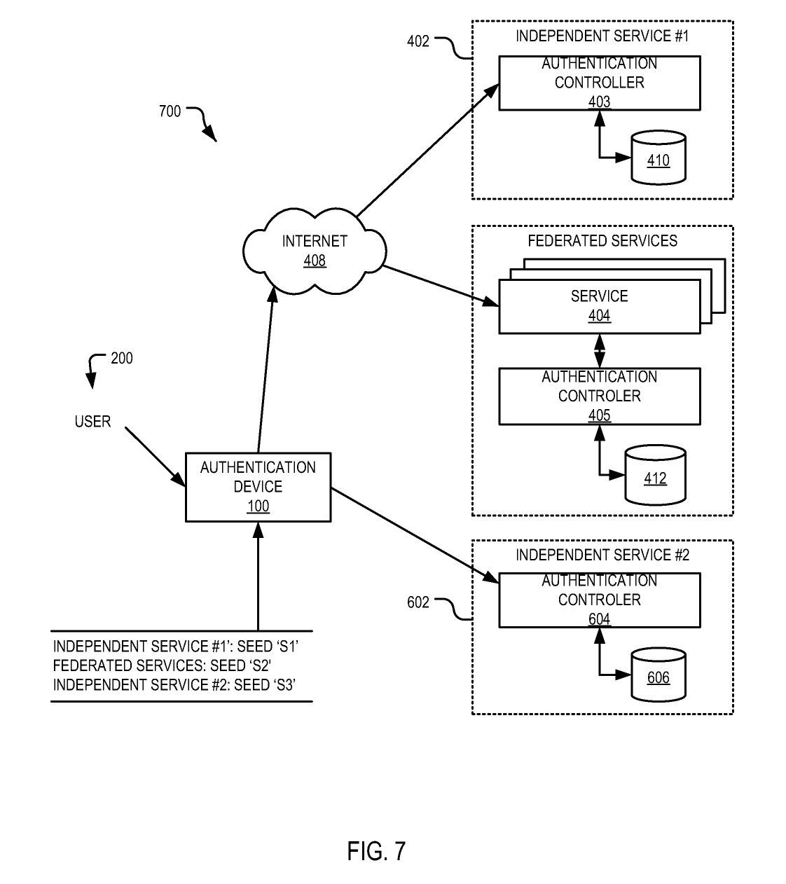

With reference now to FIG. 7 there is shown a block diagram of an authentication system 700 having a generally similar architecture to the authentication system 600 illustrated in FIG. 6. The authentication system 700 includes the services 402, 404, 602 the authentication system 600. However, in this example, the authentication device 100 includes a communications interface (not shown) for data communication with communications infrastructure for service 402, 404, 602. As described earlier, the communications interface may include a wired or wireless interface such an IEEE802.11 based wireless interface, a general packet radio service (GPRS) compatible interface, a wireless application protocol (WAP) compatible interface, a Bluetooth interface, an optical interface (such as an IrDA interface), an audio interface, a magnetic interface (such as a magnetic stripe), a ZigBee interface, a universal serial bus (USB) interface or the like. Suitable communication interfaces would be well known to a skilled reader.

An authentication device 100 which includes a communications interface will permit data communication of a generated authentication code to the respective service 402, 404, 602 without the requiring the user 110 to manually enter the authentication code into a communications terminal and thus may render the authentication device simpler, or at least more convenient, for operation by the user.

An authentication device according to embodiments of the present invention has advantages over other authentication devices. For example, embodiments of the authentication device permit secret keys for multiple services, including services of different risk categories, to be stored and managed in a single device, thereby circumventing the need for a user to keep multiple devices. Furthermore, embodiments of the authentication device may be configured to store secret keys for additional or new services after the device has been issued to the user, thus permitting the card to be used to authenticate the user to further services, thus providing improved flexibility in operation.

Finally, it will be appreciated that various modifications and variations of the invention described herein will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are apparent to those skilled in the art are intended to be within the scope of the present invention.

1. An authentication device, including:
a data store for storing plural secret keys, each of said secret keys associated with one of a plurality of corresponding services;
a service selection means for selecting a service from the corresponding services;
an authentication code generator for generating, from the secret key associated with the selected service, a one time usable authentication code for communication to an authentication controller associated with the selected service; and
an output interface for outputting the generated authentication code for communication to the authentication controller.

2. An authentication device according to claim 1 wherein at least one of the stored secret keys is associated with a federated service.

3. An authentication device according to claim 1 wherein at least one of the secret keys is associated with an independent service.

4. An authentication device according to claim I wherein the corresponding services include federated and independent services.

5. An authentication device according to claims 1 wherein the corresponding services include services of different risk categories.

6. An authentication device according to claim 1 further including plural counters for maintaining a count value for ones of the plurality of corresponding services, the count value indicating the number of said one time usable authentication codes generated by the authentication device.

7. An authentication device according to claim 1 wherein the output interface includes a communications interface for outputting the generated authentication code for electronic communication to the authentication controller.

8. An authentication device according to claim 7 wherein the communications interface includes a wired or wireless communications interface.

9. An authentication device according to claim 1 wherein the authentication device includes a smart-card arrangement.

10. An authentication device according to claim 9 wherein the smart-card arrangement includes an arrangement of user controls providing the service selection means.

11. An authentication device according to claim 10 wherein the user controls include a respective control for each of the corresponding services operable by a user to select the service from the corresponding services.

12. An authentication device according to claim 1 wherein the authentication device includes a mobile communications device equipped with a set of computer program instructions.

13. An authentication device according to claim 1 wherein the authentication code generator includes a processing unit and a software implemented algorithm implemented by the processing unit.

14. An authentication device according to claim 13 wherein the software implemented algorithm provides a different cryptographic function for each service of the corresponding services.

15. An authentication device according to claim 14 wherein the software implemented algorithm selects the cryptographic function according to the selected service.

16. A method of authenticating a user to a service, the method including:
storing plural secret keys in a data store of a user device, each of said secret keys associated with one of a plurality of corresponding services;
the user operating the user device to select one of the corresponding services;
the user device generating an authentication code for authenticating the user to the selected service, the generated authentication code being derived from the secret key associated with the selected service; and
outputting the generated authentication code for communication to an authentication controller associated with the selected service.

17-20. (canceled)

21. A method according to claim 16 further including providing a different cryptographic function for each service of the corresponding services, and selecting the a cryptographic function for generating the authentication code according to the selected service.

22. A computer readable media including a set of instructions in the form of a computer software program, the instructions being executable by a processing device on-board an authentication device including a data store storing plural secret keys, each a said secret keys being associated with one of a plurality of corresponding services, the execution of the instructions causing the authentication device to:
prompt a user to select a service from the corresponding services;
generate, from the secret key associated with the selected service, a one time usable authentication code for communication to an authentication controller associated with the selected service; and
output the generated authentication code for communication to the authentication controller.
